(19) United States
(12) Patent Application Publication
(10) Pub. No.: US 2001/0050610 A1
(43) Pub. Date: Dec. 13, 2001

(54) Hospital informatics system

(76) Inventor: Arthur Gelston, Outremont (CA)

Correspondence Address: Wayne M. Kennard, Hale and Dorr LLP, 60 State Street, Boston, MA, 02109, US

(21) Appl. No.: 09/870,246

(22) Filed: May 30, 2001

(30) Foreign Application Priority Data
May 30, 2000 (CA) 2,310,154
Dec. 15, 2000 (CA) 2,328,545

(51) Int. Cl. G06F 7/04; H04Q 1/00

(52) U.S. Cl. 340/5.53; 705/2; 340/5.83; 340/5.74

(57) ABSTRACT

The present invention provides a computer-based system for providing decision support in a hospital environment. The computer-based system includes: a plurality of electronic color coded displays comprising data fields wherein the displays are modeled upon or closely depict hospital information formats selected from the list comprising: order forms, patient records, status reports, information screens, medical imaging results or lab results; a plurality of terminals, wherein each terminal has user interactive means for displaying the color coded images for user interaction with the system; biometric means operatively associated with each terminal for efficient identification of the authorized user; computer means enabling images to be accessed in of an interactive manner by an authorized user; data storage means; a central data processing system supporting system logic wherein the central data processing system can transfer information between the plurality of terminals and one or more database servers; one or more database servers for transferring information between the data storage means and the central data processing system; and system logic, modeled on hospital procedures, wherein the logic comprises two types of decision support, one that is user interactive and one that functions independently of user commands.

### FIELD OF THE INVENTION

This invention relates to information systems within hospital settings.

### BACKGROUND OF THE INVENTION

There is a need to efficiently and accurately make decisions regarding patient treatment and care a hospital environment and to have the actions following those decisions be carried out as if quickly as possible. It is also important that correct information identifying the patient and his or her condition follow the patient as he or she moves through the hospital, as it is often desirable to switch patients among various rooms.

Various electronic communications systems annunciators and doctors registers have been designed for and used in hospitals. Such communications systems have generally been designed to communicate among various facilities in a hospital, to provide particularized nurse or physician call signals, or to provide silent paging systems and information identifying particular physicians who are in the hospital at any given time.

For example, U.S. Pat. No. 4,967,195 to Shipley shows a multi-drop audio communications system for use in a hospital that also includes conventional nurse call and patient emergency switches. Requests for nursing assistance, including those made for patient shower facilities and other potentially dangerous areas, are communicated over multi-drop buses to the nursing station via a central controller. The conventional dome light outside the patient's room is activated and the nursing station is also alerted to the patient's request for assistance. The system of the Shipley '195 patent also provides prioritizing of verbal communication calls among hospital facilities. There is a basic architectural similarity between the system disclosed in Shipley '195 and the preferred embodiment of the present invention in that a central controller polls a plurality of remote controller devices to which peripheral devices are attached and all communication among different remote controllers are effected via packets passed through the central controller.

The prior art has also provided plural lighted indicators associated on a one-to-one basis with patients in particular rooms that indicate particular patient requests. For example, U.S. Pat. No. 2,910,680 to McLain shows a patient-to-nursing station annunciator system wherein each patient room is provided with a keyboard having a plurality of keys that may be depressed in order to activate particular lights at a nurses station indicating, for example, that the patient requests the nurse's assistance, needs water, or to have other services performed. Setting of the lamps is controlled at the patient's room and is also cleared there. Thus, the system of the McLain '680 patent provides only a silent annunciator providing a visual indication of a patient service request.

An electronic patient tracking system for use in a hospital, particularly a hospital emergency room facility is provided by U.S. Pat. No. 5,760,704. This invention provides a plurality of patient tracking modules, each of which includes a multi-character display for indicating a patient's name and complaint as well as an indicator of attending physician and nurse. Illuminated colour coded switches are used to indicate the placement of orders for work to be done. The system provides automatic timeouts if the order is not completed, as evidenced by subsequent operation of a switch, within a predetermined period of time and changes the lamp status to an alarm condition, such as flashing with a particular cadence. The system allows local entry of data and setting of order indicators as well as the control of these elements from a host computer system of the hospital in which the device is used. It also provides for a complete transfer of identification information and order status among patient modules when a patient is moved between rooms associated with particular modules.

Computerised medical systems for diagnosing and/or treating a patient is provided by U.S. Pat. No. 5,988,851, wherein the system has a controller for controlling the system-specific components. The controller works together with an input device and is additionally assigned a data storage unit in which it is possible to store at least one operating menu. The operating menu can be called up by means of the input device and can be displayed on an indicating or display device. The operating menu includes a plurality of operating functions which can be selected, e.g., by means of a movable marker. When an operating function is selected its associated executable function is executed under control of the system controller. The system is further provided with the functionality of allowing a user to freely select specific operating functions from among the totality of operating functions assigned to the one or more operating menus and store the selected functions in the data storage device grouped as a separate, independent operating menu. This independent operating menu can thereafter be displayed as a separate menu on the indicating or display device and utilised as a more direct means for executing those functions grouped with the independent operating menu.

A computerised medical system to monitor, diagnose, prioritise and treat a plurality of remotely located patients is provided in U.S. Pat. No. 6,024,699, wherein the system uses a central data processing system configured to communicate with and receive data from a plurality of respective patient monitoring systems. Patient monitoring systems are capable of receiving and storing patient data and may include a medicine dosage algorithm for using the stored patient data to generate medicine dosage recommendations for a patient. A central data processing system is configured to obtain patient data from each patient monitoring system and analyse the obtained patient data to identify medical conditions of each respective patient. A central data processing system may include medicine dosage algorithms. Identified patient medical conditions for each respective patient are displayed in selectable, prioritised order according to medical severity via one or more remotely located clients in communication with a central data processing system. Modifications to medicine dosages, medicine dosage algorithms, patient fixed or contingent self-monitoring schedules, as well as other treatment information, may be communicated directly to a patient or to a patient monitoring system.

A computerised care management system in which the management of the administration of care for patients is provided in U.S. Pat. No. 5,781,442. Hospital information systems are monitored and the information from those systems is used in verifying the administrations of care to patients. The care management system monitors ongoing administrations for progress and automatically updates records and provides alarms when necessary. The care management system is modular in nature but is fully integrated among its modules. Particular lists of data, such as the termination times of all ongoing infusions, provide hospital staff current information for increased accuracy and efficiency in planning. Features include the automatic provision of infusion parameters to pumps for accurate and efficient configuration of the pump, and providing an alarm when an unscheduled suspension of an infusion exceeds a predetermined length of time.

None of the above mentioned computerised systems, however, provide a single integrated system that can track patient care, facilitate the prescription of medications and procedures, present results of patient tests, assist in scheduling caregiver timing, etc. Thus, a need remains for an improved integrated system that can provide a wide multiplicity of information management pertaining to patient care in a hospital environment.

### SUMMARY OF THE INVENTION

An object of the present invention is to provide a hospital informatics system using colour-coded screen displays and intuitive navigational cues that are specifically designed with the perspective of the medical care provider to efficiently and effectively support decision making and the carrying out of instructions. The computer-based system includes: a plurality of electronic color coded displays comprising data fields wherein the displays are modeled upon or closely depict hospital information formats selected from the list comprising: order forms, patient records, status reports, information screens, medical imaging results or lab results; a plurality of terminals, wherein each terminal has user interactive means for displaying the color coded images for user interaction with the system; biometric means operatively associated with each terminal for efficient identification of the authorized user; computer means enabling images to be accessed in an interactive manner by an authorized user; data storage means; a central data processing system supporting system logic wherein the central data processing system can transfer information between the plurality of terminals and one or more database servers; one or more database servers for transferring information between the data storage means and the central data processing system; and system logic, modeled on hospital procedures, wherein the logic comprises two types of decision support, one that is user interactive and one that functions independently of user commands.

### BRIEF DESCRIPTION OF THE FIGURES

FIG. 1 presents a schematic representation of one embodiment of the present invention.

FIG. 2 presents a schematic of the chart module according to FIG. 1.

FIG. 3 presents a schematic of the clinical data entry module according to FIG. 1.

FIG. 4 presents a schematic of the nursing functions module according to FIG. 1.

FIG. 5 presents a schematic of the clinical guide module according to FIG. 1.

FIG. 6 presents a schematic of the MD functions module according to FIG. 1.

FIG. 7 presents a schematic of the kardex and pharmacy module according to FIG. 1.

FIG. 8 presents a schematic of the admitting module according to FIG. 1.

FIG. 9 presents a schematic of the order entry module according to FIG. 1.

FIG. 10 presents a schematic of the administration module according to FIG. 1.

FIG. 11 presents a schematic of the system architecture of one embodiment of the present invention.

FIG. 12 presents another schematic of the system architecture of one embodiment of the present invention.

FIG. 13 shows an example of a computer screen used for examining the most recent results for one patient, Francois Simplon, selected from the background list of patients. The results screen was brought forward by selecting the Erlenmeyer flask icon.

FIG. 14 shows an example of a computer screen used for examining the clinical signs for a patient selected from the list of patients. The results screen was brought forward by selecting the graphics icon.

FIG. 15 shows a screen that demonstrates clinical signs presented graphically, along with the drug administration for a patient.

FIG. 16 depicts a computer screen showing the fluid Ins and Outs for one patient, Samuel By Bemelmans. The data for this patient is presented as dated raw data and graphically. The total Ins and Outs are also provided.

FIG. 17 depicts a computer screen with the hospital chart for a single patient, Samuel Bemelmans. On the right hand side of the screen there is a series of buttons, which can be selected in order to read and/or write in various portions of the hospital chart. In this case, MD Notes ! have been selected by the user, Arthur Gelston, Medical Staff. The notes are shown on the left hand side of the screen and contain the date and time that the entry was made and the name and position of the person who made the entry. By clicking on the backward (B) and forward (F) hands at the bottom of the screen, the user can go through the notes in the hospital chart.

FIG. 18 shows a computer screen with a window used for writing a note in a patient's file, in this case Samuel Bemelmens'. By using the physical finding button the user is able add more information to the file.

FIG. 19 depicts a computer screen with a clinical signs data entry window for a single patient, Samuel Bemelmens. On the right hand side there is a window with areas for entering data related the patient's vital signs. The window on the left contains the clinical signs for the patient with the time they were input into the system. A third window appears in front of the left and right windows. This window is opened if the user wants to enter a message into the system.

FIG. 20 shows a screen prompting the caregiver to select a dosing frequency. It also reports the most recent blood sugar. This dosage frequency selection screen was brought forward by selecting a dosage of the drug, Acarbose 50 mg, from the menu on the Prescription Order Entry for Medications screen.

FIG. 21 demonstrates a menu driven dosage frequency selection screen for Acetamenophen 650 mg, that was brought forward by selecting Acetamenophen 650 mg from the list of available medications.

FIG. 22 shows a screen presenting information pertaining to accepted indications for the drug Amikacin. The selection screen also presents an alternative drug, Gentamicin. Drug prices are presented, wherein the cost for the selected dosage and frequency is presented on a cost/week basis.

FIG. 23 presents a computer screen demonstrating selection from a list of drug classes, such as analgesics, that will enable the care provider to select from the list of analgesics in order to formulate a prescription.

FIG. 24 demonstrates the aspect of the system wherein one can select a diagnostic/therapeutic order profile from a list.

FIG. 25 demonstrates an order set for congestive heart failure, selected from the list in FIG. 9. This screen presents an order profile for diagnosis of this condition.

FIG. 26 presents an exemplary Prescription Order Entry for Medication. In particular, this screen demonstrates the development of a prescription (see box, upper right) that will be sent to the pharmacy. Drug costs are also displayed, tracked and recorded.

FIG. 27A presents the prescription order entry process for hospital personnel according to one embodiment of the present invention.

FIG. 27B presents the prescription order entry process incorporating the decision support of the system according to one embodiment of the present invention.

FIG. 28 demonstrates a computer screen showing a nursing Kardex. Some key features are the active prescriptions for a specific date, the current IV solutions, and the drug administration record for that day. It also shows which tests are performed on that day.

FIG. 29 shows an example of a computer screen indicating nursing activities on Oct. 19, 1999. The screen includes separate windows, which may be organised by room or by nurse, that contain information regarding nursing activities for individual patients. Activities are indicated by icons which represent admission, drugs administered, IV, etc.

FIG. 30 shows a computer screen with windows indicating various components of the personal care plan for a single patient, Samuel Bemelmans, including routine care, IV care, catheter care, nursing prescription and special needs. An additional window summarizes the functional assessment of the patient.

FIG. 31 shows a computer screen used for patient tracking in the emergency room of a hospital.

Each window represents a single patient and contains information including the patient's name, time of arrival and initial symptoms. Each window contains icons which represent classes of action that may be taken, including prescription, drugs administered, admission, ambulance. The colour of each icon is indicative of action taken.

FIG. 32 shows a computer screen as in FIG. 21 with a single patient, Katrina Theodopoulas, selected. A new window has opened showing more detailed information relating to the colour coded information in the previous screen. Lines shown on the chart indicate the time and duration of each action taken. Multiple actions are shown for some of the classes.

FIG. 33 shows a computer screen in which a triage order entry window has been opened for a single patient, Samuel Wolfe. This window is used to select laboratory tests and image examinations based on a working diagnosis. Once a working diagnosis is selected, in this case “abdominal pain”, then an appropriate list of tests and examinations appears on the right hand side of the window.

FIG. 34 shows a computer screen with an interactive formal functional assessment form, for cognitive assessment of a single patient, Samuel Bemelmans. In each section of the assessment form there are questions followed by a choice of response that may be selected by the user, in this case Linda Armstrong, RN, in evaluating the cognitive abilities of the patient.

FIG. 35 depicts a computer screen with a Clinical Systems—Ward order administration window.

FIG. 36 depicts a computer screen with the Laboratory Test Administration window.

### DETAILED DESCRIPTION OF THE INVENTION

This system provides an informatics tool that facilitates the physician and the health care team to make informed diagnostic therapeutic decisions and transparently integrates the clinical activities of physicians, nurses and paramedical personnel. Immediate access to the latest clinical information, combined with the individual patient information, and results of other similar age-matched patient results, provides the healthcare team with dynamic interactive decision-support capabilities. It can also be used for scheduling decisions for a ward, given the types of patient disorders and time required for each. This system is particularly useful for use in a multidisciplinary team approach where all members have concurrent access to the same information.

Furthermore, the modular construction of the system enables the addition of modules specifically designed for each speciality within the hospital environment such as neurology, oncology, orthopedics and pediatrics, wherein each module can incorporate additional decision support associated with the particular discipline upon which it is associated. For example a pediatrics module will include prescription order entry schedules which correspond to standard pediatric practise (for example mg/kg and mg/m² dosing schedules).

The system is designed with two major divisions of decision support: one is focused on the interaction between the user and the system, such as during order entry for a prescription or viewing patient test results; the second runs as a background process that functions independently of user interaction to provide support to the hospital personnel by using triggers to identify pre-determined scenarios relating a specific situation, such as a critical combination of vital signs. Moreover the system logic and triggers, which are created using algorithms and boolean statements can be generated in plain language by the system administrator at the hospital to tailor both divisions of decision support to a hospital's current practice. For example, system administrator forms allow the user in plain language to select from different categories such as diagnostic, demographic, current medications, and sets of laboratory and/or clinical data, and in those domains make plain language statements which the system then can string together into boolean statements that will alert hospital personnel of a situation that needs to be brought to their attention.

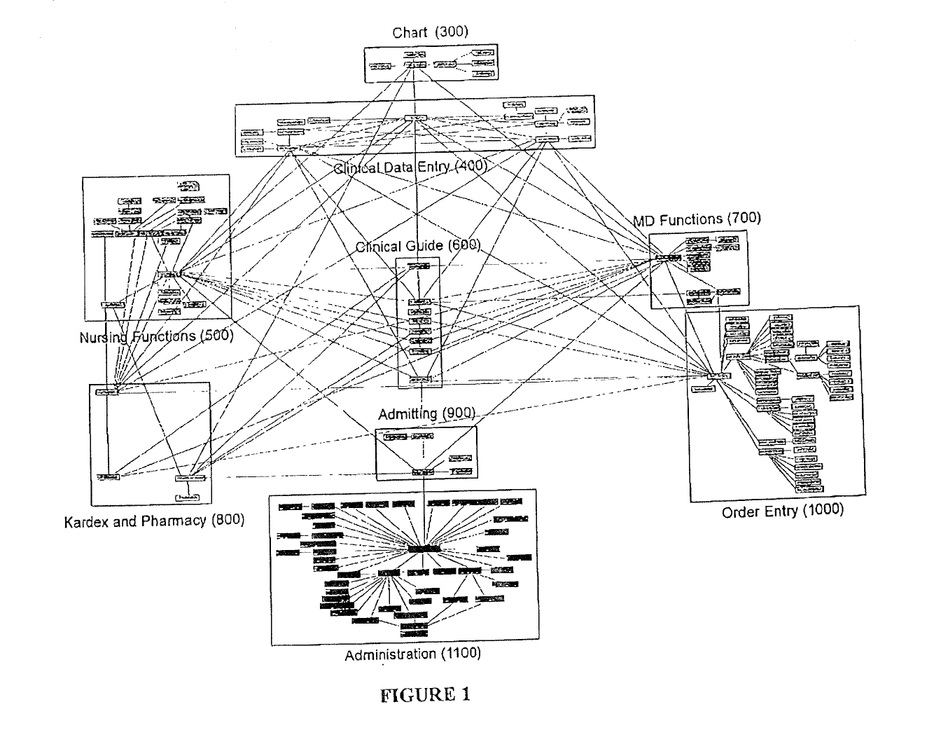

Primary aspects of this system include the designs of the colour-coded screen displays that optimise the quality, type and amount of information presented to the health care provider such that they can navigate easily and intuitively through the system to access the information useful for the decision(s) at hand in addition to instructing others such as through prescriptions of drugs, tests, or procedures, etc. Supporting the ability to navigate through the system is the computer system logic, one example of which is described in FIG. 1, which closely models the processes and procedures typically used in a hospital. Another feature is the ability for a system administrator in a hospital to use plain language to easily and continuously tailor the system to their specific hospital standards and procedures and moreover, to modify the system to the specific practices within a department such as the pediatric department. The system is also designed to accumulate the wealth of experience of the hospital personnel which can be brought to the attention of a health care provider when it is relevant to a decision they are about to make, such as regarding adverse drug events or patterns in patient treatment for a specific indication.

The interface between a user and the system is provided by a plurality of screen displays or colour coded images, which provide a means for hospital personnel to interact with the hospital informatics system in an easy and efficient manner. Said screen displays can be displayed for the user, for example, on a computer monitor. A plurality of links is integrated into the screen displays providing a means for a user to navigate between screens in an efficient manner. Said links further provide a means for connecting relevant information together, for example, a patient's current active prescription and recently performed tests can be immediately accessed by the click of a button.

The screen displays are further configured to emulate current standards for hospital documentation, providing a means for the ease of transition between current printed documentation and an electronic system. By using symbols typically used in a hospital environment, the information contained on a particular screen display can be efficiently understood by the hospital personnel. Furthermore, information regarding for example lab results for a patient can be displayed in numerical form or graphical form based on the preference of the user. In a related embodiment the images are further configured using symbols used by a specific hospital, therefore allowing the system to be tailored to various hospital settings.

In one embodiment of the present invention, colour can be used to denote the navigation method. Buttons are organised into colour groups related to function. For example, in a preferred embodiment mustard-coloured buttons are used to navigate to “external” forms, i.e., other clinical screens not related to the currently active function type. Dark blue buttons are used to navigate to “internal” forms, i.e., other clinical screens related to the currently active function type (seen on the principal order entry forms, for example). Salmon-coloured buttons are usually used for Cancel/Continue operations or operations where records are being manipulated. Orange buttons are used to filter records in data lists. Light blue buttons are used to access forms displaying supplementary information concerning the currently active clinical function. Off-white buttons are used to modify demographics records.

In a further embodiment, the colour scheme is also sensitive to whether the user is colour-blind. Given the fact that approximately 7% of the population is colour-blind, it is important that this is taken into account. Thus, when an individual enters into this system using biometric identification scanners, the colours used in the visual display automatically change to accommodate for their colour blindness, if appropriate.

The screen displays can be colour coded, providing a means for the hospital personnel to evaluate a situation quickly at a glance. By for example, coding functions, which are late as red, hospital personnel are immediately notified, upon viewing the screen display.

Means of rapid, accurate and simple user identification such as biometric fingerprint identification, using optical scanners, is used for the validation of a user requesting access to the system. As is typical with many computing networks and systems, access to various features and information on the system can be restricted to particular users. Furthermore, the biometric identification procedure can be used to sign or authorise prescriptions, diagnostic tests and discharges, for example. This procedure provides a means for rapid identification of all users of the system and reduces the security risks which are inherently associated with user identification passwords.

This system encompasses a plurality of activities performed within a hospital setting and provides a means for the immediate transfer of information, which is entered and/or requested by hospital personnel. The system provides a means for hospital personnel to provide high quality and individualistic care, with this care being based on the most current information regarding a particular patient. Modular software integrates, for example, physician expert order entry with clinical nursing activities as well as numerical and image test results. The system further comprises a plurality of decision modules, with these modules providing hospital personnel with options and assistance for determining a method of treatment. These algorithms for the decision support modules can be based on, for example, current patient information, the most recent treatment protocols for the particular ailment, the protocol of a particular hospital or local practise standards and statistical data collected and processed by the hospital informatics system.

In one embodiment of the system, there are a number of interactive modules as described below.

A Dynamic Interactive Database

The database includes the latest clinical guide information that is updateable. This information is accessed in different situations, such as when prescribing a drug, or analyzing lab results. The data base also comprises patient records which are updated in real-time with laboratory and nursing input so the most current information is always at hand. This information comprises the results of all tests including EEG, EKF, X-rays, CAT scans, MRI scans, etc.

The system uses Tree logic (whereby parts deeper in the tree can take precedence over later) to provide the healthcare team with action directives based on patient information (eg. Age, weight, sex, prognosis) drawing upon past experiences with similar patients.

The system uses a menu driven data entry method where the user does not know data type to be entered, but just uses the ENTER key and the down arrow to make selections based on automatic display of possible data allowed, by the system. Method of order generation using branching menus and button selection. Color-coded windows and intuitive navigational cues guide the user through standard procedures such as admitting and discharging patients, prescribing medications and treatment, picking up physician orders or viewing test results.

Dynamic Interactive Prescription Module

The method of prescribing lab work, patient care or prescriptions includes an optical scanner verification system. Translation method for transforming MD prescriptions from the Latin format into hours and/or a schedule. It also includes a U.I. for the kardex. The healthcare team is provided with suggestions and information pertinent to the information that was input, which can be over-ridden. Physician prescriptions are transmitted directly to the Kardex, care plan and hospital pharmacy.

The diagnosis-based order sets can be prescribed with just one keystroke. Prescriptions are legible and dosages are calculated on the basis of individual patient parameters. The system dynamically reviews all prescriptions and suggests alternative courses of therapy based on local practice standards. Clinical signs, diabetic flow sheets, and input and output data are all immediately available to contribute information to system decision-support algorithms which alert the healthcare team before critical situations develop.

Dynamic Interactive Results Analysis Module

The module provides a decision-support system whereby the healthcare team is provided with a standardized evaluation of the implications of laboratory or other results of patient tests. The system provides context sensitive help for lab results with built-in access to the clinical guide by selecting (e.g., right-clicking) abnormal lab results. The data base allows for setting the normal and alert rangers for lab test results, by age range.

Dynamic Interactive Individual Patient Summary Module

The system will notify the healthcare team with automatically generated message depending on vital signs. The system uses a method of showing input and output data with overlay of clinical data. Use of icons and hyperlinks to bring-results. There are also Icon displays for alerts. For example, selecting a heart icon brings up the history of heart EKG's or selecting a brain icon will bring up the CAT scan or MRI scan results. Clinical signs, diabetic flow sheets, and input and output data contribute information to system decision-support algorithms which alert the healthcare team before critical situations develop.

Dynamic Interactive Scheduling/Prioritization Module

This module can be used to equitably distribute the nursing workload through the up patient information and laboratory implementation of a flexible, system-determined “Acuity Point” score which allows rational personnel scheduling. One screen demonstrates the amount of work involved in caring for patients with specific diagnosis. This module allows individual nursing units to schedule nursing duties in a flexible manner specific to the medical specialty of each particular ward, as determined by the nursing staff themselves.

Dynamic Multiple Patient Summary

This output screen demonstrates the current treatment history and current situation for a number of patients at once, thereby providing the healthcare team with a comprehensive view of the patient's progress. Each patient record is updated in real-time with laboratory and nursing input so the most current information is always at hand. Color coding indicates which patients have received attention and which are currently waiting for what type of attention. This is particularly useful in an emergency ward. This display contains a patient-tracking feature that allows wards such as the busy emergency room physician to rapidly assess the patient's progress through the various diagnostic and therapeutic stages of an ER visit. Clinical signs, diabetic flow sheets, and input and output data contribute information to system decision-support algorithms which alert the healthcare team before critical situations develop.

The present invention now is described more fully hereinafter with reference to the accompanying drawings, in which preferred embodiments of the invention are shown. Like numbers refer to like elements throughout. This invention may, however, be embodied in many different forms and should not be construed as limited to the embodiments set forth herein, rather, these embodiments are provided so that this disclosure will be thorough and complete, and will fully convey the scope of the invention to those skilled in the art.

System Overview

In one embodiment of the present invention, a system for monitoring, diagnosing and treating medical patients with various chronic illnesses, according to the present invention, is schematically illustrated in FIG. 1.

With further reference to FIG. 1, the system comprises a plurality of modules, for example, Chart 300, Clinical Data Entry 400, Nursing Functions 500, Clinical Guide 600, MD Functions 700, Kardex and Pharmacy 800, Admitting 900, Order Entry 1000 and Administration 1100. Each of these modules performs a defined set of tasks, which are designed to encapsulate and assist specific hospital personnel with the performance of their required duties. For example, the MD functions module 700 together with the Order Entry module 1000, provide physicians with a means for clinical order entry, for example prescriptions, lab tests or diagnostic tests, in conjunction with a plurality of additional assistance including decision support, which may be based on local practise standards in conjunction with current patient information. These modules are included for illustrative purposes only and a system according to the present invention may incorporate additional modules providing additional functionality without departing from the scope of the present invention.

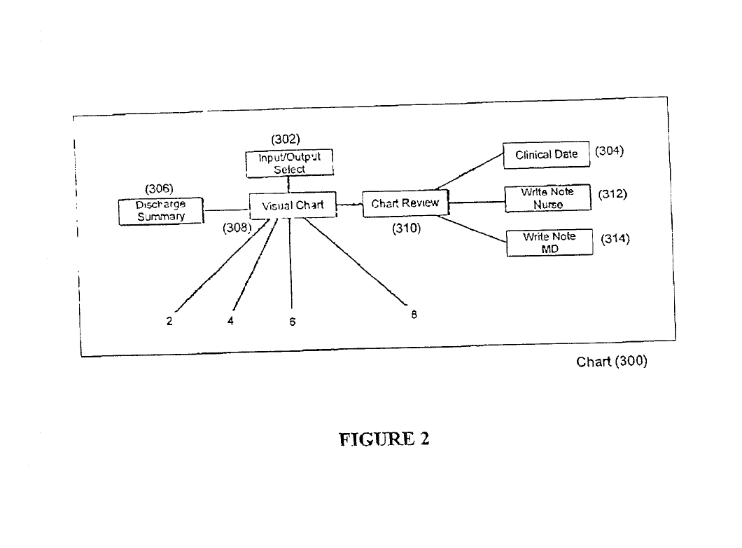

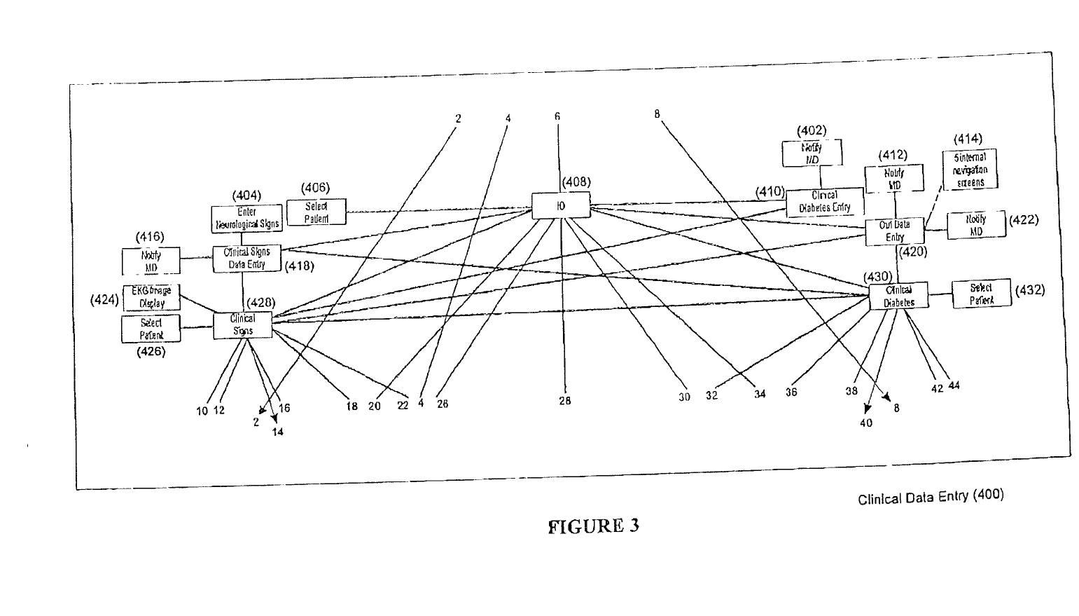

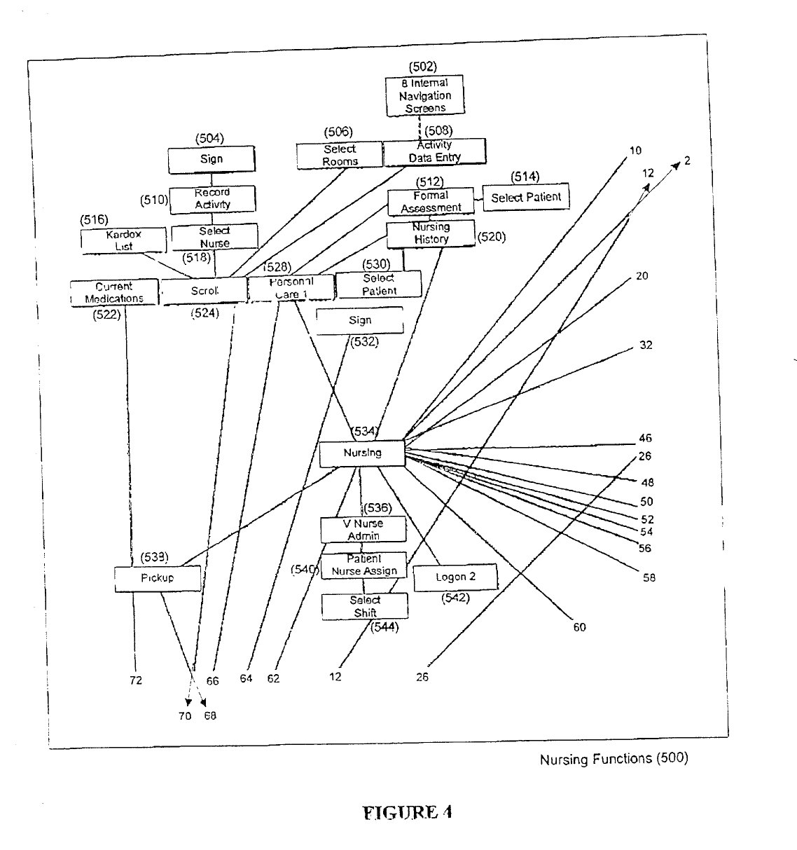

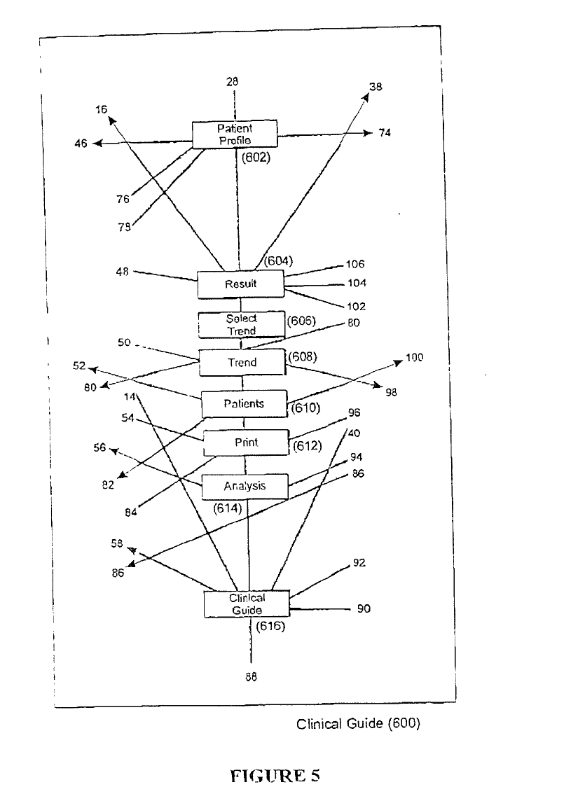

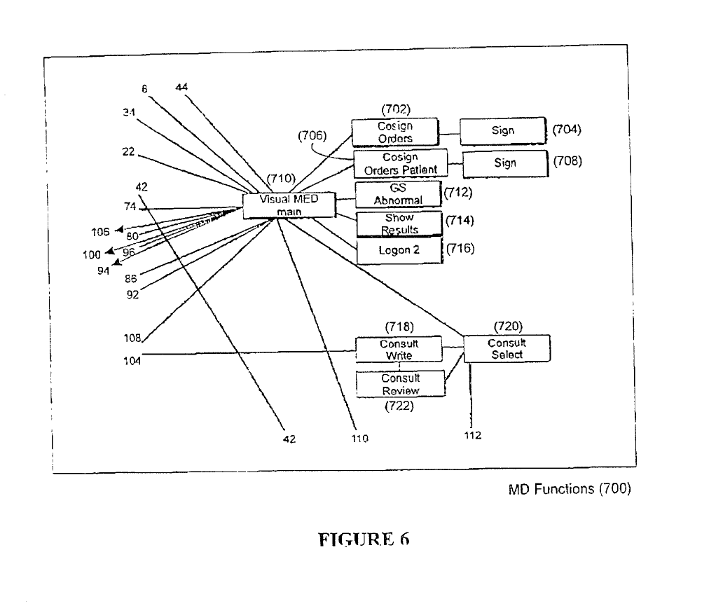

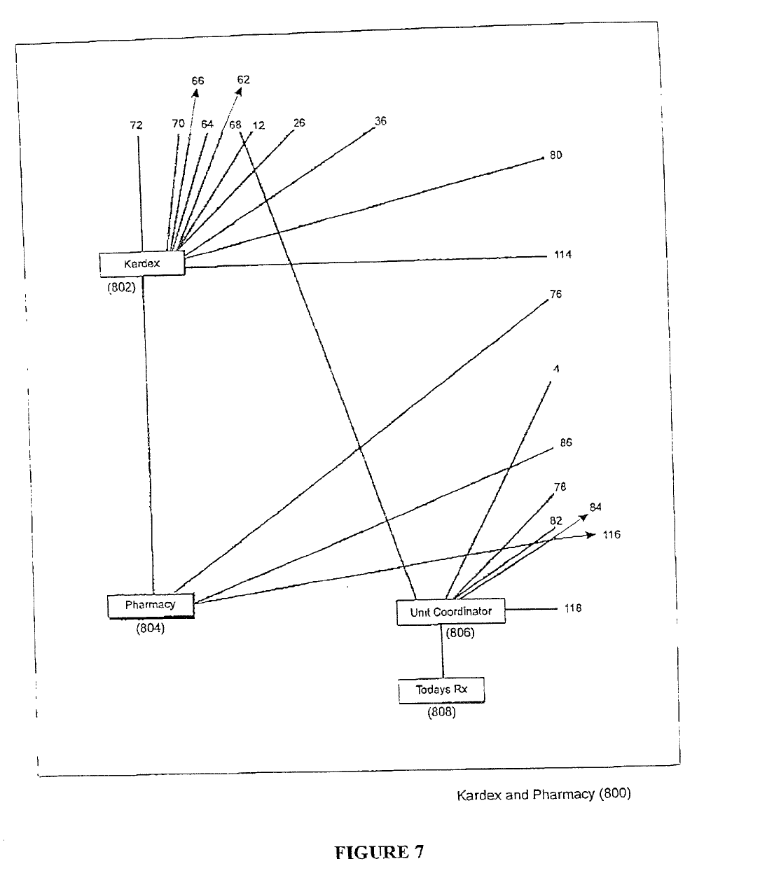

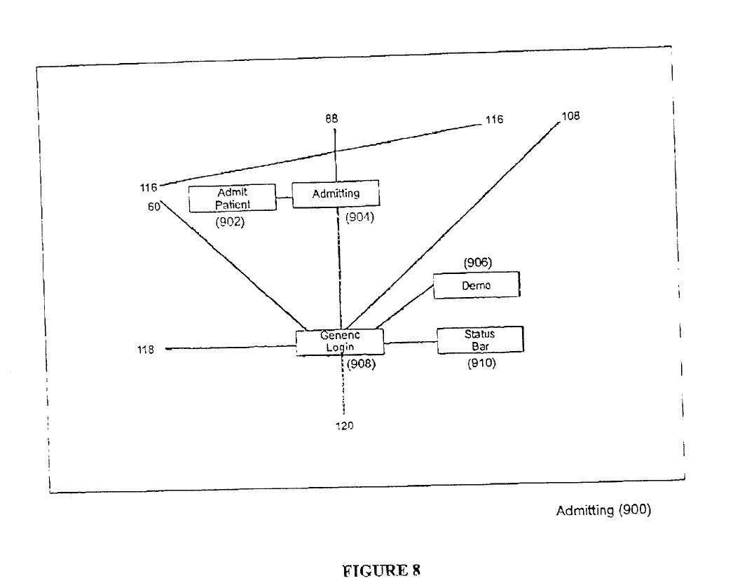

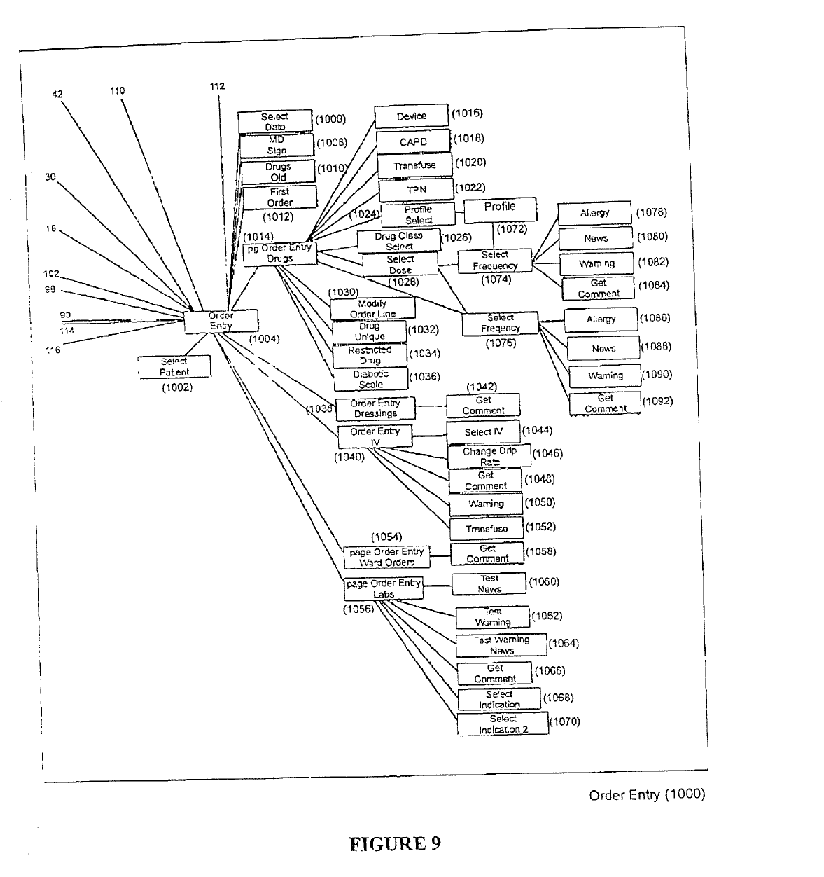

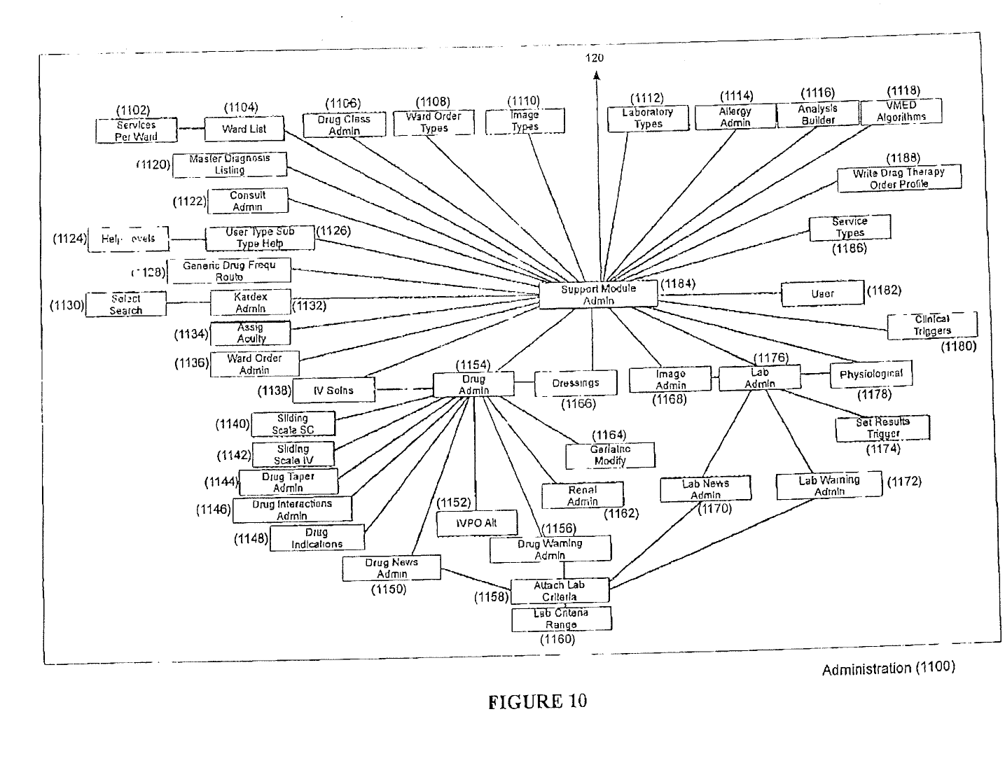

The above system, as illustrated in FIG. 1, is separated into the respective modules and schematic representations of each of these modules are illustrated in FIGS. 2-10. Straight lines connecting nodes within a module indicate the transfer pathway of information between said nodes. Furthermore, the information transfer pathways between modules are also indicated by straight lines and said pathways are sequentially number to correlate said information transfer pathways between figures.

The interconnectivity of each module of this system provides a means for enabling the efficient and rapid transfer of patient information to hospital personnel requiring said information.

Furthermore, any patient information that is entered into this system by physicians, nurses or paramedical personnel is immediately available for consultation by all users of the system. With this immediate access to the most recent patient information, hospital personnel are able to perform their duties and make decisions based on the most current information. Furthermore, decision support algorithms are incorporated into the system providing the hospital personnel with guidance during the decision making process, for example order entry decision support which comprises drug orders and lab test orders.

System Architecture

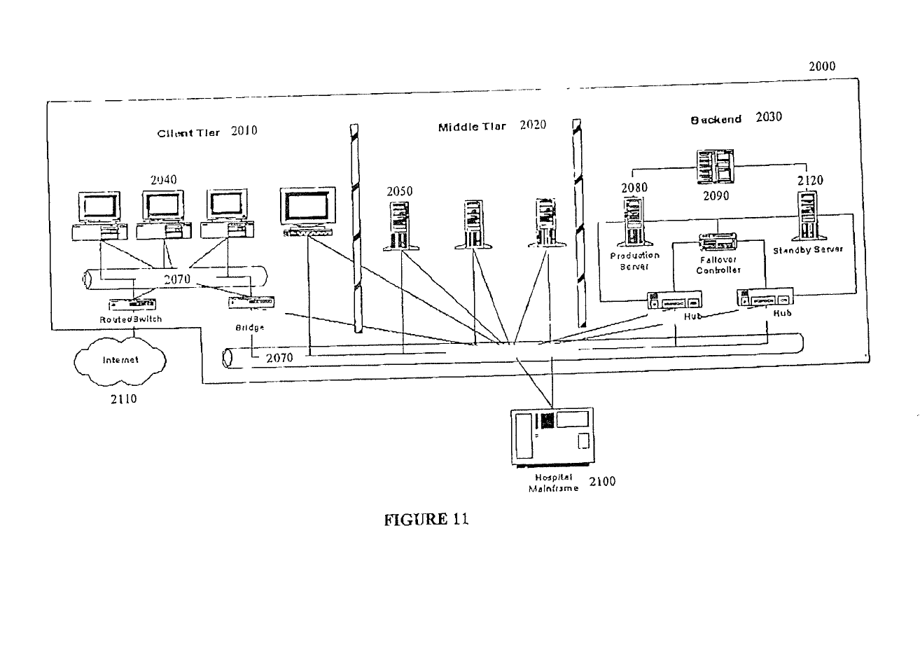

In one embodiment of the present invention, a system providing the functionality of the above monitoring, diagnosing and treating system is schematically illustrated in FIG. 11. The hospital informatics system 2000 is organised as a local area network comprising a interactive client tier 2010, a middle tier 2020 and a backend tier 2030. A plurality of interactive terminals 2040 contained within the interactive client tier 2010 are configured to establish communications directly with a central data processing system comprising a plurality of middle servers 2050, via communication links 2070, for example an ethernet. Furthermore, the middle server communicate, via communication links 2070, with the backend tier 2030 comprising one or more database servers 2080 and one or more databases 2090. The communication links 2070 of the present invention can have varying information transfer rates with these rates being dependent on the quantity and required speed of information transfer between components using said communication links. Furthermore, it is possible to have varying information transfer rates depending on the communication link 2070, for example the transfer rate of the link connecting the backend tier 2030 to the middle tier 2020 may be greater than that connecting the client tier 2010 to the middle tier 2020.

It is understood that a middle server, a database server or other apparatus configured to execute program code embodied within computer usable media, operates as means for performing the various functions and carries out the methods of the various operations of the present invention. It is also understood that the present invention may be used with various client-server communications protocols, and is not limited to specific protocols such as TCP/IP protocol.

The system is a mission-critical application with hardware and software configured for 24 hours ×7 days a week uptime. The three-tiered client-server architecture as illustrated in FIG. 11, is scaleable and can support any number of concurrent users. Depending on the hardware selected for the middle tier and backend tier, several thousand clients can use the system concurrently.

In one embodiment of the present invention and with further reference to FIG. 11, the hospital informatics system 2000 can interface with a plurality of computing systems external to its local area network, for example, the hospital mainframe 2100, the internet 2110 and pre-existing computing systems contained within the hospital comprising diagnostic systems and imaging systems. This interconnectivity is provided by the use of for example, specific protocols like HL-7 and customised interfaces, enabling the integration of the present invention into a pre-existing hospital environment, without the need for replacing existing computing systems.

Interactive Terminals

The interactive terminals provide a means for hospital personnel to interact with the hospital informatics system, enabling hospital personnel to enter and view information pertaining to a particular patient for example.

In one embodiment of the present invention, the interactive terminals are designed to have as small a “footprint” as possible, therefore reducing the space required by the terminals. For example, flat screens can be used for reducing the size of the computer monitor and/or the interactive terminals can be wall mounted to further reduce space requirements.

In one embodiment of the present invention, the screens are touch-capable which enhances the functionality of the unique graphical user interface. Navigation through the screen images can be improved by the use of touch-capable screens as compared with typical mouse navigation. Furthermore, based on the environmental conditions in which the interactive terminals are operating, the functionality of a mouse which is used for screen navigational purposes may deteriorate at an accelerated rate.

In one digital optical scanners which scan the fingerprint of the user are used for quick and easy identification processes. The system also sues optical scanners in a validation method for cosigning orders. User identification is provided by digital optical scanners to enable appropriate access to patient records in addition to entries and orders such as prescriptions to be validated.

In one embodiment of the present invention, only the required information is transferred to the interactive terminals from the central data processing system, enabling rapid viewing and presentation by the terminals of the transferred information. For example, information will not be retransmitted if it is already contained on the interactive terminal, thus accelerating the perceived response time of the system. The functionality of the interactive terminals may be limited to the presentation of said information, therefore these terminals may only require software providing a means for communicating with the central data processing system and a means for translating this transferred information into the interactive screen displays.

In accordance with one aspect of the present invention, there is provided a data management system for hospitals that can facilitate the diagnosis, tracking, monitoring, treatment of a plurality of patients using a central data processing system configured to communicate with and receive data from a plurality of respective patient monitoring systems, wherein each patient monitoring system is capable of receiving and storing patient data, the system comprising: a central data processing system, a central data storage unit, a dynamic interactive prescription creation module, a patient tracking module, one or more optical scanners for user identification and a dynamic interactive patient care order module.

Central Data Processing System

In one embodiment of the present invention, the central data processing system provides a means for information transfer between the interactive terminals and the one or more databases and operates using a plurality of connected middle servers. Furthermore, the middle servers contained in the central data processing system are configured such that the computational load experienced by each of the middle servers can be balanced through the integration of an allocation procedure for example, Dynamic Server Allocation (DSA). The DSA subsystem defines a mechanism by which tasks are dynamically allocated to middle servers. This allocation is based on the availability and current load of a pre-determined set of middle servers dedicated to the middle tier. DSA allows clients to obtain their services from the most “available” middle server in an ad-hoc or dynamic basis. This configuration of the central data processing system allows for the seamless addition of an unlimited number of middle servers, thus enabling the number of interactive terminals to increase simultaneously if so desired. For example, the central data processing system can incorporate a cluster of Windows-NT™ servers. Examples of the high-performance Windows NT machines that are used in one embodiment of the present invention are, IBM Netfinity™ and HP D-Class™.

In one embodiment of the present invention the business logic or computational algorithms are contained within the central data processing system, reducing the computation requirements of the interactive terminals. Thus the complex database information, which may be required for the execution of these algorithms, is only known to the central data processing system. Furthermore, the workload required to execute these algorithms may be distributed over a plurality of middle servers contained in the processing system, accelerating the computation speed of the system, thus increasing the rate at which the requested screen displays are presented on the interactive terminals.

Databases and Database Servers

With further reference to FIG. 11, the backend tier 2030 comprises one or more databases 2090 and a plurality of database servers 2080. As would be known to a worker skilled in the art, the present invention employs redundant components providing operational redundancy, allowing the system to function irrespective of failure of one or more components in the backend tier. For example, the system will automatically switch from a primary server 2080 to a backup server 2120, in the event of a fault in the primary server 2080. In a preferred embodiment of the present invention, the system uses UNIX database servers as backend servers, operating with RAID technology, for example IBM RS6000™ or HP 9000™ . In a preferred embodiment, system data is stored in Oracle 8i tables running under UNIX.

In one embodiment of the present invention, patient reporting workstations, which are independent of the local area network of the system, are strategically placed within the hospital providing a means for clinical hospital procedures to continue in the event of a complete failure of the hospital informatics system.

In one embodiment of the present invention the one or more databases store and accumulate information relating to a plurality of patients, with this patient information comprising, personal information (address, age, weight, allergies etc.), current ailments, current prescriptions, lab results and diagnostic test results (MRI, CT scan, X-ray etc).

Software Interaction Between Tiers

In one embodiment of the present invention, the core of the hospital informatics system is a collection of Component Object Model (COM) objects, which interact with each other and with the interactive terminals, wherein said COM objects are contained within the middle tier of the systems architecture. Transmission of the information across the local area network of the hospital informatics system is provided by Distributed Component Object Model (DCOM) and Multi-tier Distributed Applications Services Suite (MIDAS). DCOM is a is a protocol that enables software components to communicate directly over a network in a reliable, secure, and efficient manner, as would be known to a worker skilled in the art. MIDAS is a suite of advanced components, servers, and core technologies for multi-tier application development, wherein these services enhance those provided by DCOM. These COM objects provide data from the database and computing services (for example, middle servers) to other objects and the interactive terminals. In the present invention the COM objects are organised according to the principle of “separation of concern”. Each COM object is completely responsible for a single entity or role in the system, for example one COM object can be responsible for the management and data browsing of all drugs in the system.

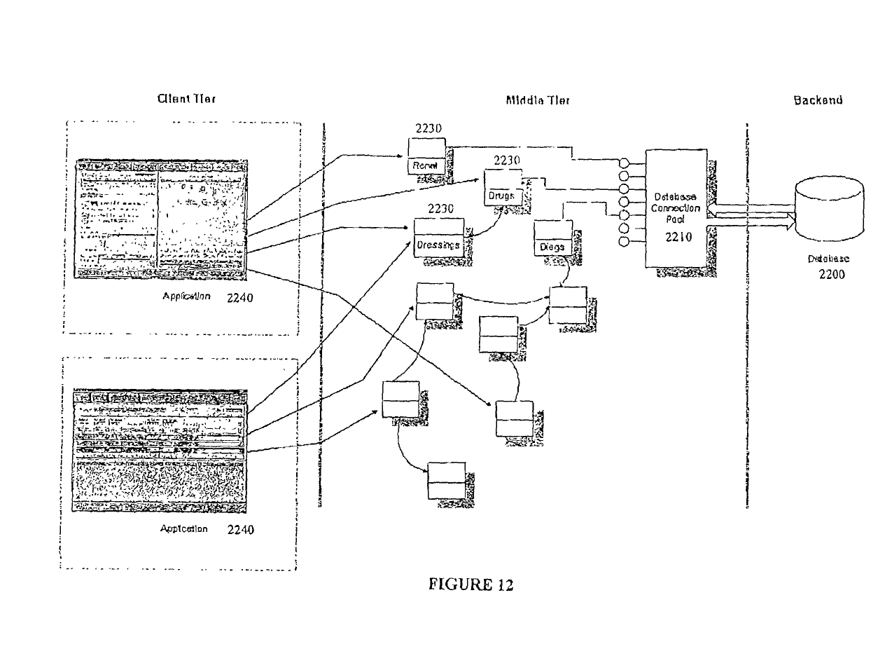

In one embodiment of the present invention, the construction of two screen images is schematically represented in FIG. 12. The requested screen images 2240 are constructed with data fields of information extracted from the COM objects 2230. The COM objects 2230 are run on middle servers and during the execution of said COM objects, required information is extracted through a database connection pool 2210, from a database 2200 containing the required information. As is illustrated in FIG. 12, the data fields of information required to construct a screen display on an interactive terminal may be extracted from multiple COM objects.

Functionality of the System

In order to more fully understand the functions of a system operating in accordance with the present invention, the following detailed descriptions are provided with reference to the Figures. The interconnectivity of the modules contained within the system results a funtional dependence between various modules, thus the follow descriptions are described in relation to the operation of the system in particular scenarios related to particular embodiments of the present invention and not as individual modules themselves.

Patient Charts

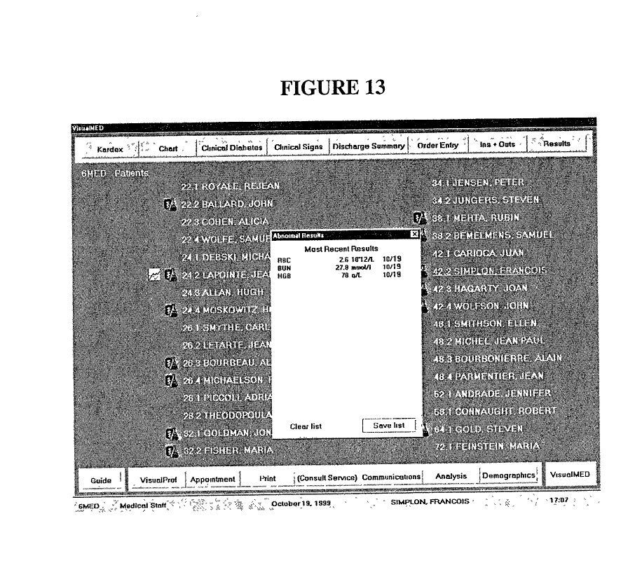

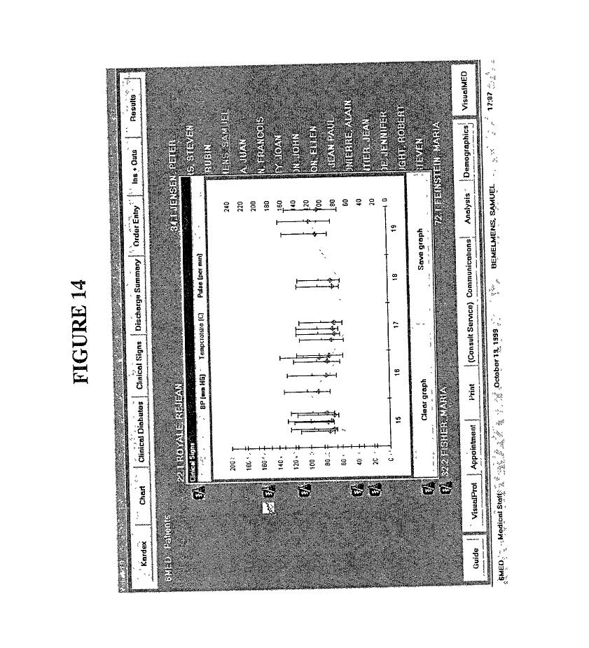

In one embodiment of the present invention and with reference to FIG. 13, hospital personnel, upon authorisation of access to the system, can be presented with a screen display indicating the patients under their care. Lab results for a particular patient in this case Francois Simplon are viewed by selecting the Erlenmeyer flask icon indicated beside the patient's name. By selecting the graph icon, vital signs for the selected patient can also be displayed as indicated in FIG. 14. This provides a means for hospital personnel to view lab and diagnostic results, for example abnormal, with regard to any patient under their care, without the need for referring to a plurality of printed charts. In one embodiment of the present invention, these Erlenmeyer flask and graph icons can be associated with abnormal test results and vital signs, respectively. These signals of abnormal results and signs can be automatically generated by the system and can be evaluated based on a predetermined set of parameters, thus providing a means for immediately notifying hospital personnel of any problem.

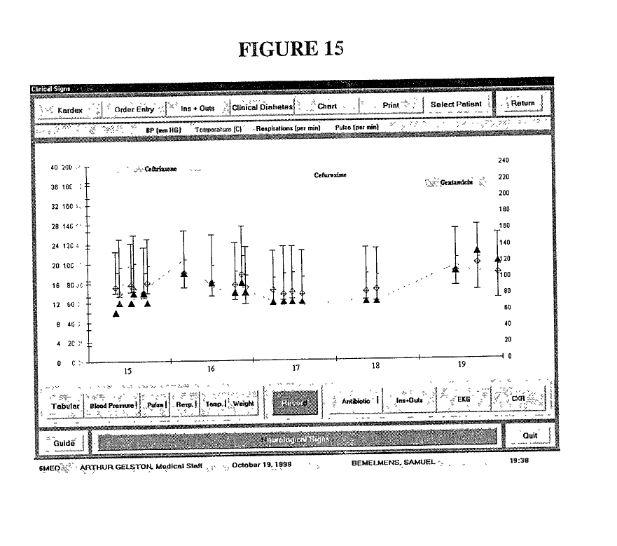

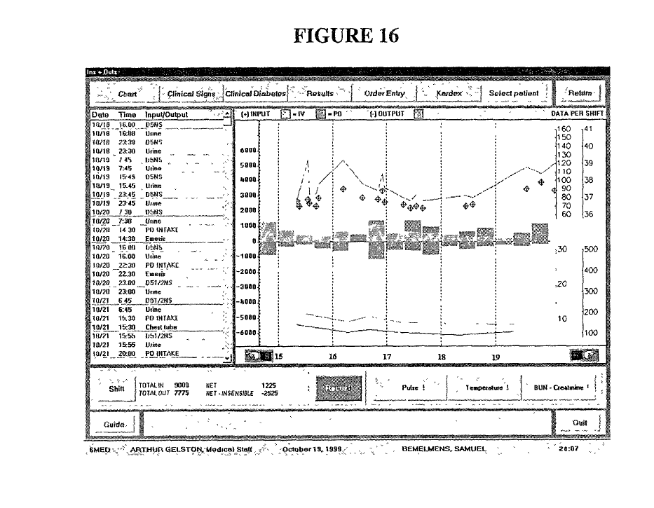

Located at the top of the screen display as indicated in FIG. 14 there is a link to a complete set of clinical signs with respect to a selected patient, which when selected will result in a screen display as illustrated in FIG. 15. This figure illustrates, in a graphical form, a complete set of the clinical signs of a particular patient including any drug administration over the selected time period. Through the selection of one of the buttons located at the bottom of the screen display, hospital personnel can view one of the clinical signs at a time, for example blood pressure, or pulse. By selection of the Ins+Outs button, FIG. 16 will be displayed indicating a complete list of the ins and outs with respect to the selected patient. For example, this information can be displayed on a graphical display and in an alphanumerical format, thus providing a means for the hospital personnel to review the information in a preferred manner.

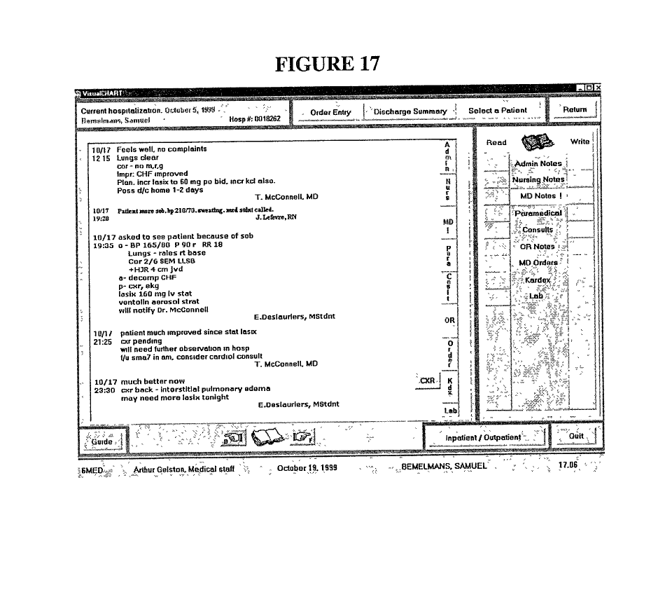

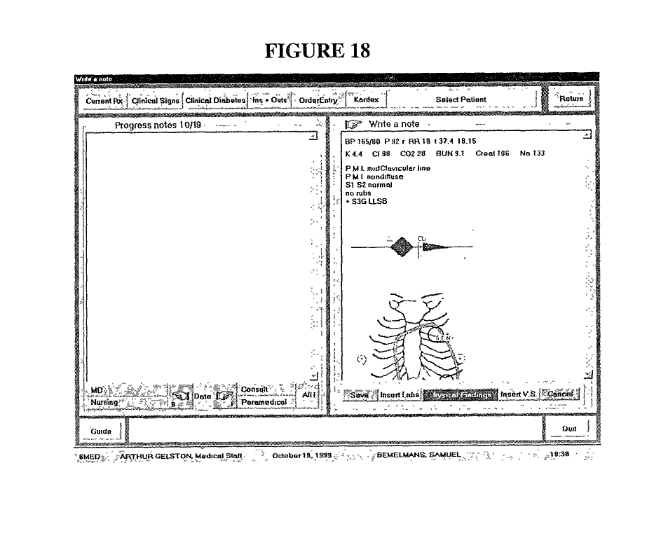

With further reference to FIG. 16, by selecting the Chart button, the electronic chart of the selected patient will be displayed as illustrated in FIG. 17. This type of a charting method is similar to the typical paper copy that will be maintained in a hospital setting. On the right hand side of the screen there is a series of buttons, which can be selected in order to read and/or write in various portions of the hospital chart. In this case, MD Notes ! has been selected by the user, Arthur Gelston, Medical Staff. The notes are shown on the left hand side of the screen and contain the date and time that the entry was made and the name and position of the person who made the entry. By clicking on the backward (B) and forward (F) hands at the bottom of the screen, the user can go through the notes in the electronic hospital chart. With the selection of the write button as indicated in FIG. 17 a note can be written into a patient's file. Referring to FIG. 18, the note can include text and images, with the images being inserted by selecting the Physical Findings button at the bottom of the write note window.

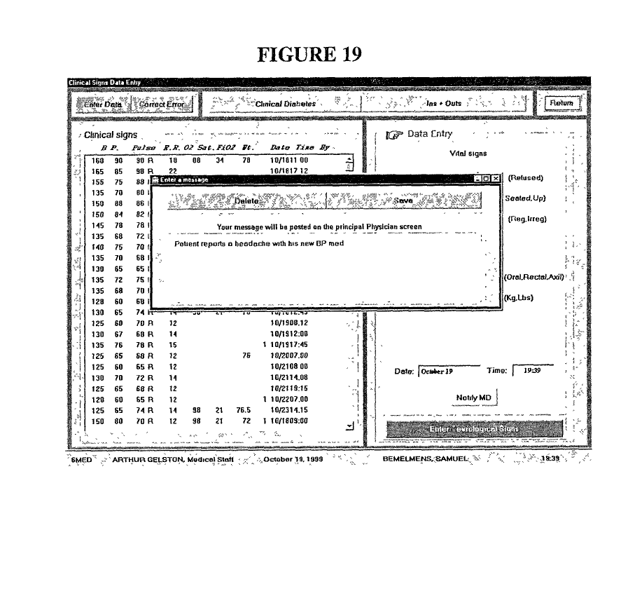

The interconnectivity of system provides a means for all hospital personnel to transmit notes relating to any patient to other personnel dealing with said patient. For example a nurse may wish to inform a patient's primary physician regarding a newly prescribed drug as indicated in FIG. 19. This note can be indicated as an envelope icon and will appear beside the particular patient's name on the screen display illustrated in FIG. 13, for example, upon access of the system by the particular user. This procedure of note transmission provides a means for hospital personnel to send and view notes immediately, independent of their location in the hospital.

Order Entry

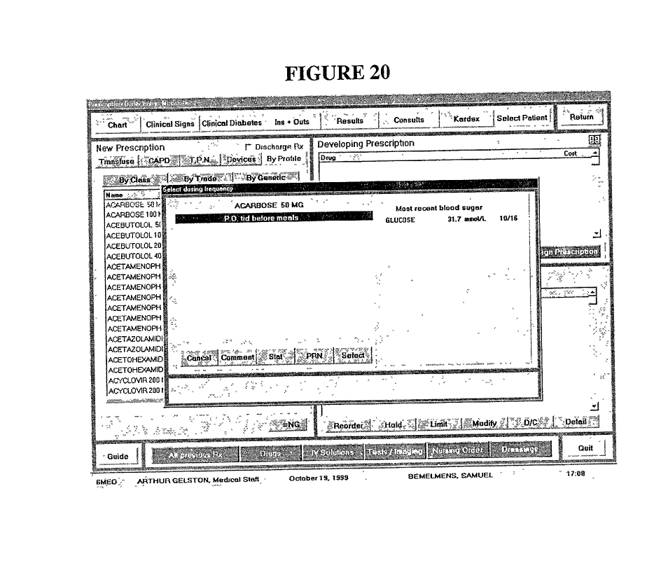

In one embodiment of the present invention, the order entry provides a means for selecting a plurality of orders for a particular patient, with these orders comprising drugs, dressings, IVs and lab tests. For the purpose of this discussion prescription order entry will be described with reference to FIGS. 20-26.

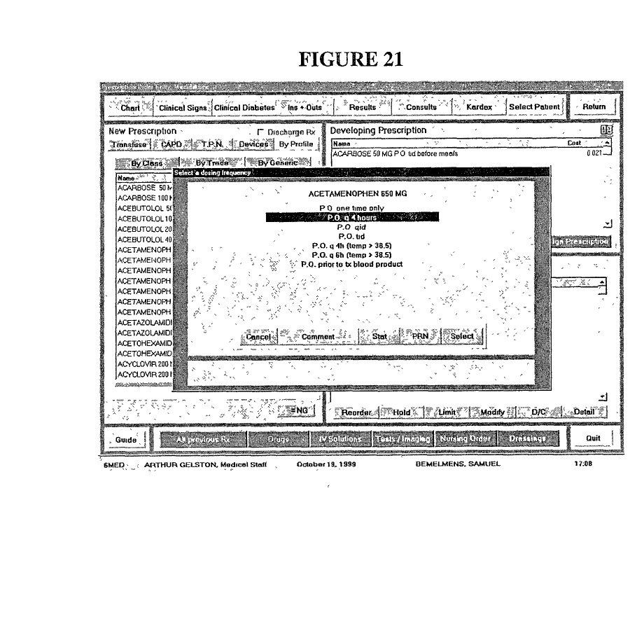

FIGS. 20 and 21 illustrate the prompt screen for the selection of the dosing frequency for acarbose and acetamenophen, respectively. These suggested frequencies may be dependent on the drug selected and the institution's policy for the administering of the particular drug which was selected in the New Prescription window.

With reference to FIG. 20, the selection of the drug acarbose further prompts the system to display the most current blood sugar test results for the selected patient. Acarbose is used in the treatment of diabetes, as it helps control blood sugar levels. Thus the presentation of the most recent blood sugar information pertaining to the specific patient enables the hospital personnel to evaluate the effectiveness and/or quantity of acarbose being prescribed based on the most up to date information, thus improving the patient's care.

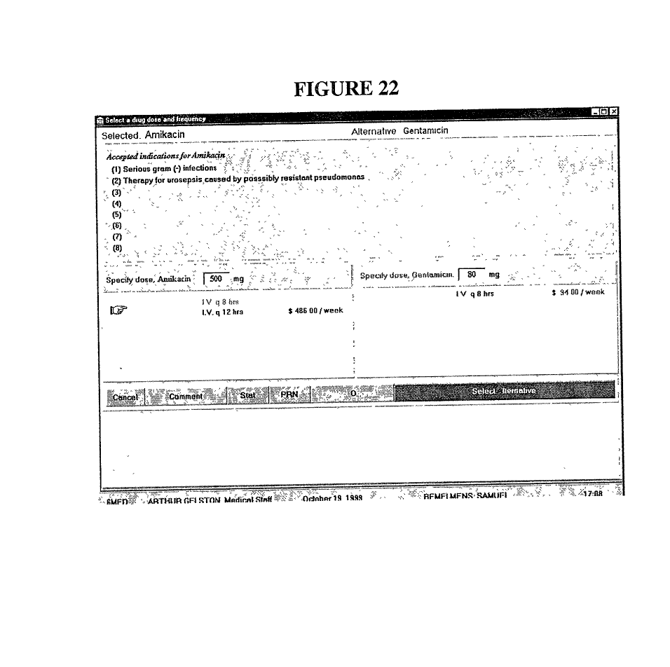

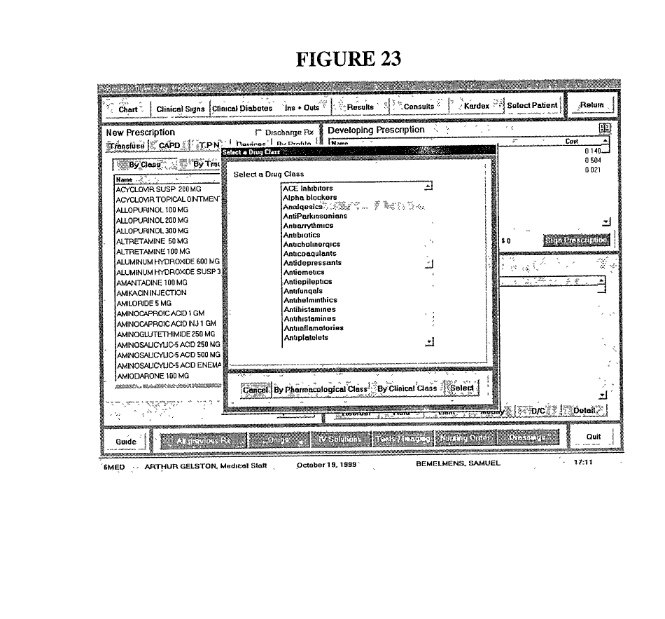

Furthermore, the prescription order entry of medications may provide alternatives to a drug, which has been selected by the hospital personnel, as illustrated in FIG. 22. In this figure amikacin was selected and an alternative drug gentamicin was suggested by the system. The selection of these alternative drugs by the system may be based on for example cost, drug incompatibility or the allergies of a specific patient. This type of interactive prescription development enables hospital personnel to develop complicated and extensive prescriptions for a particular patient efficiently and individually. The development of a prescription for a patient can also be initiated by the selection of a medication based on the class of the drug as illustrated in FIG. 23. This method provides the hospital personnel a plurality of suggestions for the selection of the appropriate medication for a patient.

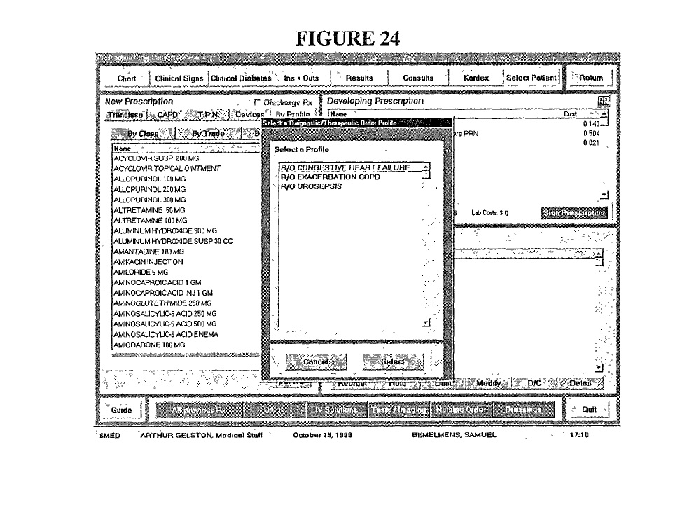

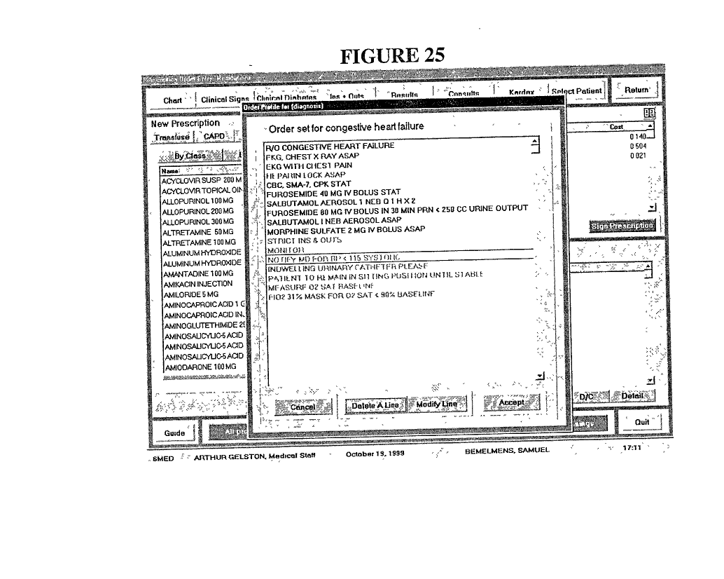

In one embodiment of the present invention, the prescription order entry of medications can also be initiated using a therapeutic order profile as illustrated in FIG. 24. In this example the patient is suffering from congestive heart failure and upon selection of this profile an order set as illustrated in FIG. 25 will be brought forward. This order set provides a means for hospital personnel to initiate a collection of orders, which are typically performed for the selected profile, with the order set including a plurality of medications, diagnostic tests and orders. As indicated in FIG. 25 by a light rectangular box, the patient's tending physician should be notified in the patient's systolic blood pressure goes below 115.

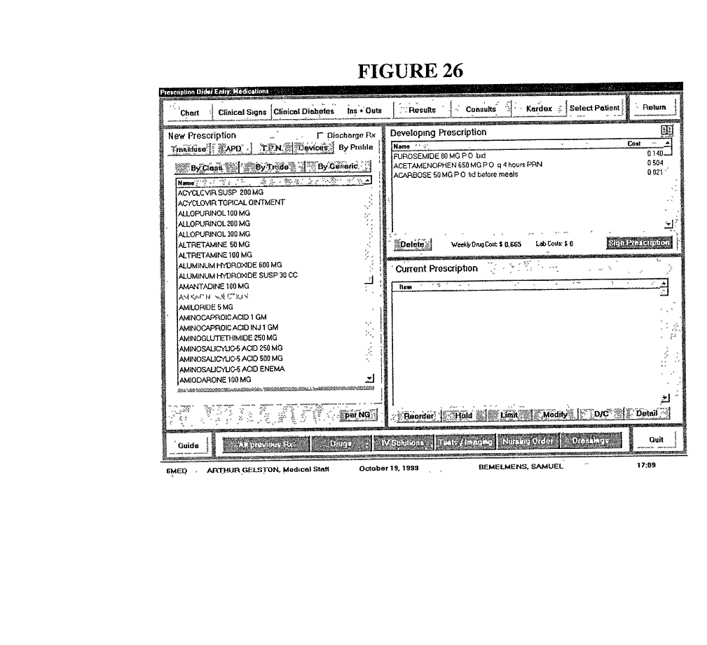

Upon selection of a drug and its dosing frequency, the medication is placed in the Developing Prescription box as illustrated in the top-right comer of FIG. 26. In this location of the order entry screen, the selected drug(s), dosing frequency and individual costs on a weekly basis for example, are displayed. Upon the signing of the prescription by authorised personnel using for example a biometric identification scanner, the developing prescription will be transferred to the Current Prescription box. Subsequently an order for the required medications will forwarded to the Pharmacy. Furthermore, the system will automatically modify previously ordered prescriptions, if necessary, based on the newly ordered prescriptions.

In one embodiment of the present invention, the prescription order entry is equipped with an automatic logout function, if a keystroke has not been performed within a defined time period. When an automatic logout occurs, the prescription order entry form is closed, the logged-on user is logged-off, any developing line orders are deleted and any current prescriptions, which were modified based on developing line orders, are reverted to their original form. This procedure provides a means for maintaining security if hospital personnel developing an order is for example distracted before the completion of the order. Furthermore, since previous prescriptions may require modification based on new prescriptions, in order to prevent drug incompatibility for example, the order entry drug module limits access to one person at a time. This provides a security barrier, restricting simultaneous drug orders which may for example result in conflicting prescriptions.

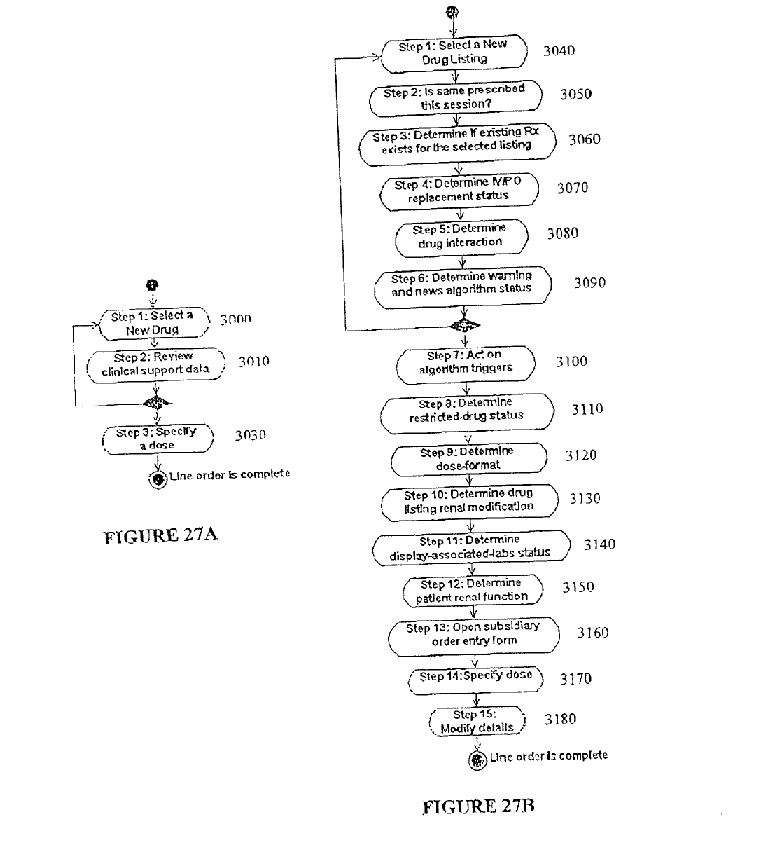

In one embodiment of the present invention, FIG. 27A illustrates the steps performed by hospital personnel during the development of a prescription and FIG. 27B illustrates the steps performed by the system during the same development of the same prescription, thus providing decision support to the hospital personnel creating the prescription. As illustrated in FIG. 25A, in order to prescribe a medication hospital personnel selects new drug 3000, as illustrated above, and proceeds to review the clinical support data 3010, provided by the system. If the hospital personnel selects to proceed with the selected medication based on the support data provided, a dose is specified 3030 at which point the medication order is complete. If however the hospital personnel decides to adjust the medication based on the support data the process returns to the beginning and a new drug is selected.

The system performs a plurality of cross checks with respect to the selected medication based on the particular patient's information and clinical data as illustrated in FIG. 25B. Initially upon selection of a new drug listing 3040, the system searches for repetitive drug listings, 3050 and 3060 with this repetition being found in the current session and/ or the existing prescription of the selected patient. The system proceeds to evaluate the replacement status of the selected drug 3070, for example if the selected drug is to be administered using an IV, the system can determine if a replacement oral medication is available. The drug-allergy interaction 3080 of the drug is established with respect to the particular patient's allergy information contained within the system and the system subsequently determines if there are any warnings or new information regarding the selected medication 3090. The information compiled by the system is presented to the hospital personnel creating the prescription thus providing decision support. Upon acceptance of the present medication the system acts on a plurality of algorithm triggers, 3100, for example algorithms used to establish the appropriate dosage. The system proceeds to determine the status of the drug, 3110, for example if the drug is a restricted substance, furthermore, if the drug is restricted, the system provides a means for the hospital personnel to make an alternate selection if so desired. The interactive prescription module proceeds to determine the dose format, 3120, and if previously determined dose should be modified based on the patient's renal function, 3130. Furthermore, in order to assist the hospital personnel in the determination of the required dose of the selected medication the system displays the lab tests or diagnostic tests which are associated with the use of the selected medication, 3140, thus providing a means for the hospital personnel to determine the appropriate dose based on the most recent patient information. During each of these steps the system notifies the hospital personnel if further modification of the prescription is required. At the completion of this procedure the system places the newly created prescription in the Developing Prescription panel for authorisation. In order to maintain integrity of the prescriptions with respect to each patient, the system automatically limits one hospital personnel to adjust a prescription of a particular patient at a time, therefore eliminating the possible interaction of simultaneously prescribed medications.

These examples of prescription ordering selection parameters have been presented in order to provide an understanding of the integration of all aspects of a patient's history, enabling the development of an effective and suitable prescription and are not meant to limit the scope of the present invention.

Nursing Functions

In one embodiment of the present invention, the hospital informatics system provides a means for organising, prioritising and distributing the nursing activities involved with hospital care.

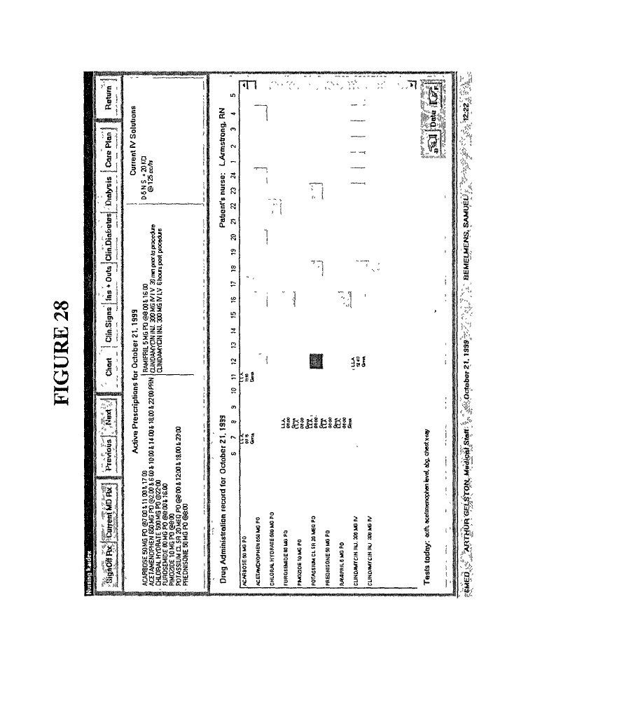

In one embodiment of the present invention, an example of a screen display generated during the use of the Nursing kardex is illustrated in FIG. 28. Some of the key features of the Nursing kardex include the active prescriptions for a specific date, the current IV solutions, the drug administration and the identification of the tests to be performed, with all of this information being in relation to the day in question. The Nursing kardex is used by nurses to maintain a record of all the drugs prescribed and administered to a particular patient. As illustrated in FIG. 28, this administration record is displayed in both alphanumeric and graphical forms. The graphical presentation of the information is provided in the form of a grid, with each of the columns corresponding to one of the 24 hours of a day and each row corresponding to a particular prescribed drug.

In one embodiment of the present invention, the starting time of the Nursing kardex day may be a system variable and may be defined in relation to the policies of the institution at the time of system installation. For example, in FIG. 28 the Nursing kardex day commences at 6 am.

Furthermore, the graphical representations of the prescribed drugs are colour and/or texture coded in order to identify the state of each prescription for any given day. For example, a prescription that was not administered at the designated time may be identified by shading the corresponding grid position red. As illustrated in FIG. 28, once the drug has been administered to a patient the hospital personnel who performed the task registers it with the system. This method of presentation will enable any authorised hospital personnel the ability to immediately identify the state of any prescription for a particular patient.

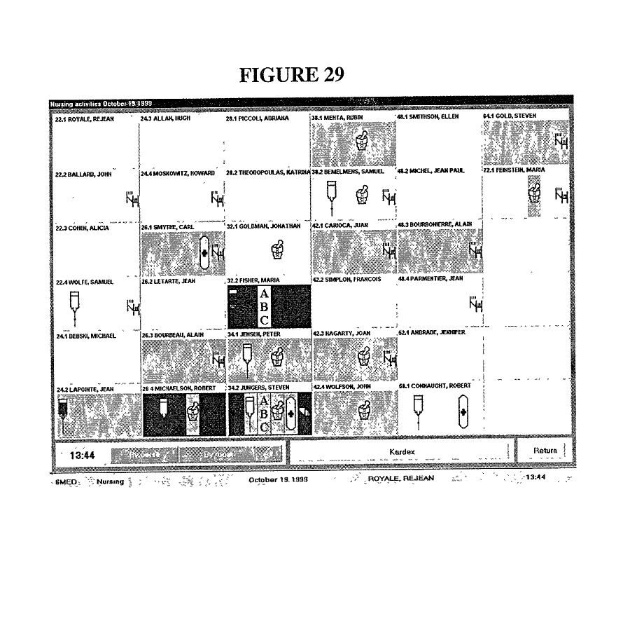

FIG. 29 illustrates a screen display indicating a set of nursing activities, which are to be performed on a particular day within for example a particular ward. In one embodiment of the present invention each grid position represents one patient with activities to be performed represented by a series of icons, indicating for example admission, dressings, medication administering and IV's. By selecting a particular icon on the screen display the duty associated with this selected icon will be identified. Furthermore, the activities can be displayed by nurse or by room by selecting the appropriate button at the bottom of the screen. This particular screen display enables hospital personnel to evaluate the work day at a glance.

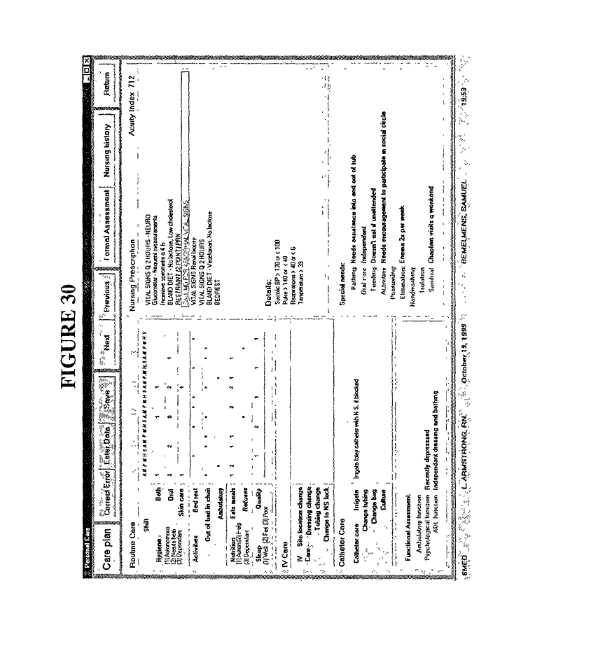

In one embodiment of the present invention, a care plan is established for every patient in the hospital, as illustrated in FIG. 30, providing a means for personalising the care of said patient. In this example the routine care, catheter care and special needs of the patient are identified. Furthermore, the top right window details the nursing prescription and particular care orders associated with a particular patient. In one embodiment of the present invention an Acuity Index is associated with each patient and is indicated in the top right corner of the Nursing prescription window. The Acuity Index is used to establish the amount of nursing care required for each particular patient, with this index providing a means for equitably distributing the work load for each nurse associated with the particular ward for example.

Each of the above mentioned nursing function screen displays will be automatically updated up the entering of new information regarding a patient.

Emergency Room Application

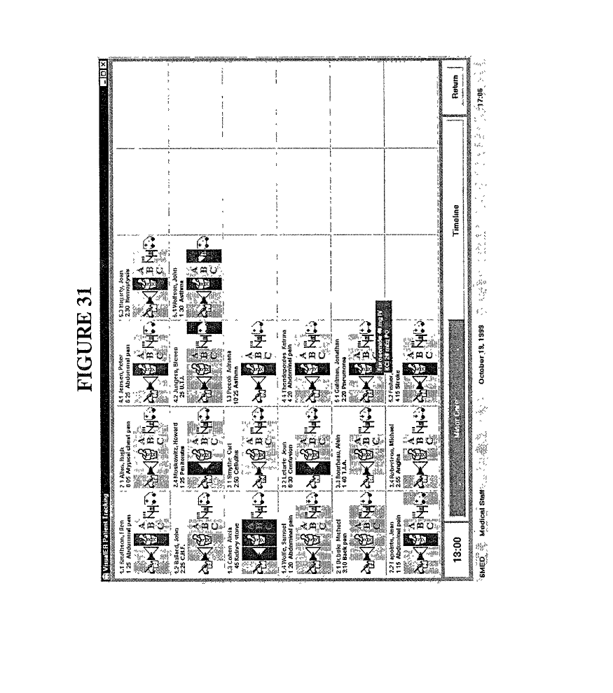

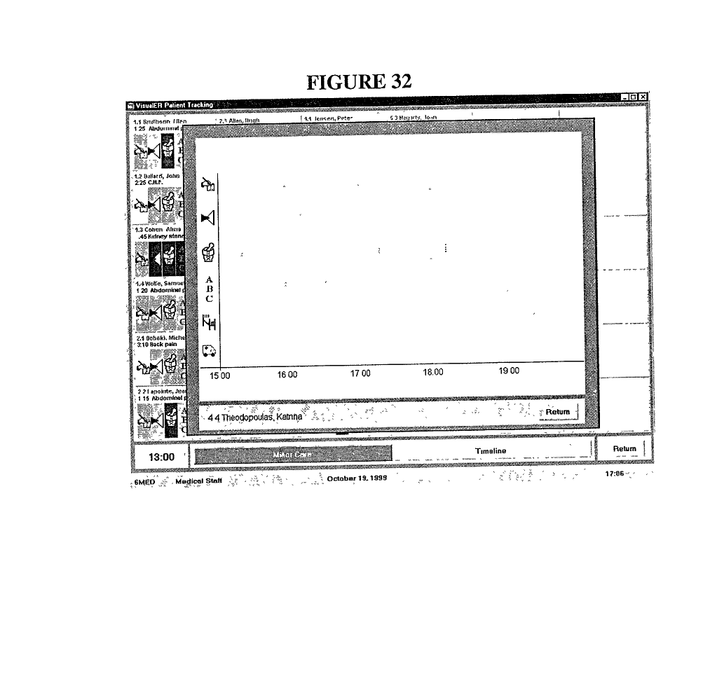

FIG. 31 illustrates a screen display of one embodiment of the present invention, which enables the tracking of patients in an Emergency Room setting. In this example the screen display is divided into a plurality of grids positions, with each grid position detailing, for example, the patient's name and ailment, in addition to further information which may be represented by an icons. These icons can represent for example, the drugs prescribed (mortar and pestle) and whether the patient has been admitted (bed). By clicking one of the icons further explanation can be displayed for example by clicking on the mortar and pestle icon associated with patient Goldman, the medication currently being administered is displayed. By clicking on the patient's name for example, information relating to the timeline for each procedure associated with the indicated icons is brought forward with respect to a particular patient as indicated in FIG. 32. Thus providing a means for the hospital personnel to immediately survey the situation relating to each patient with in the Emergency Room. Furthermore, the screen displays are colour coded, which, for example, indicates which patients have received attention and which are currently waiting for what type of attention.

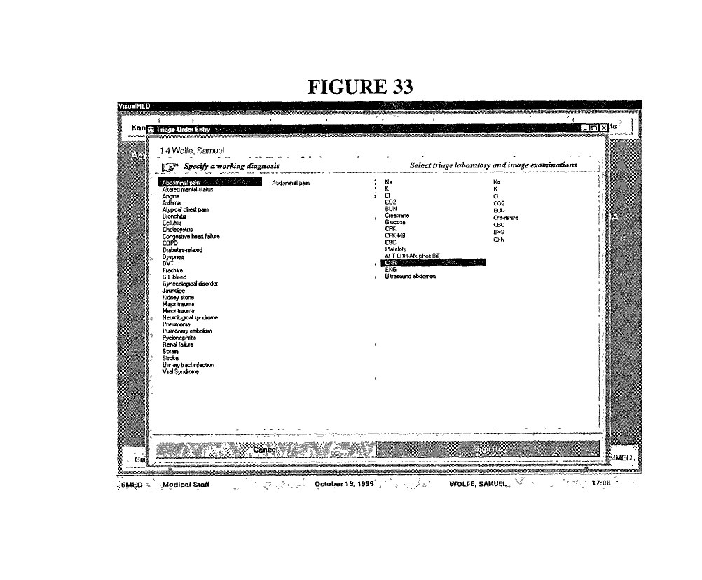

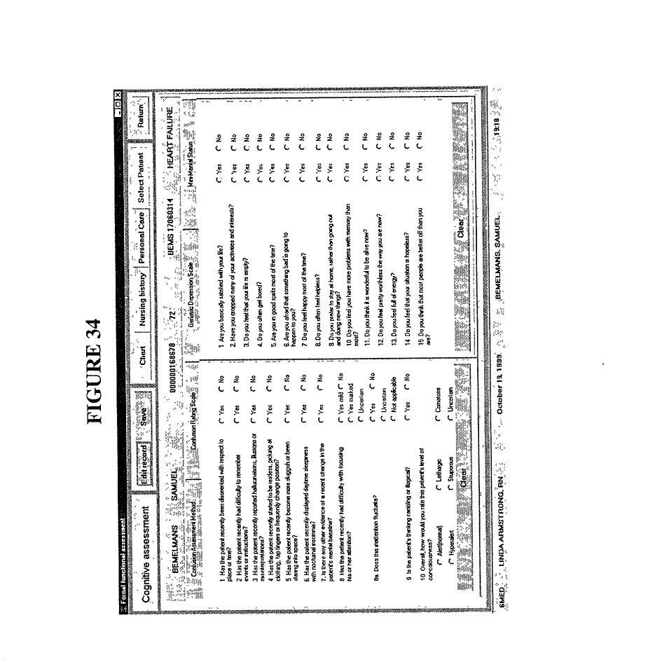

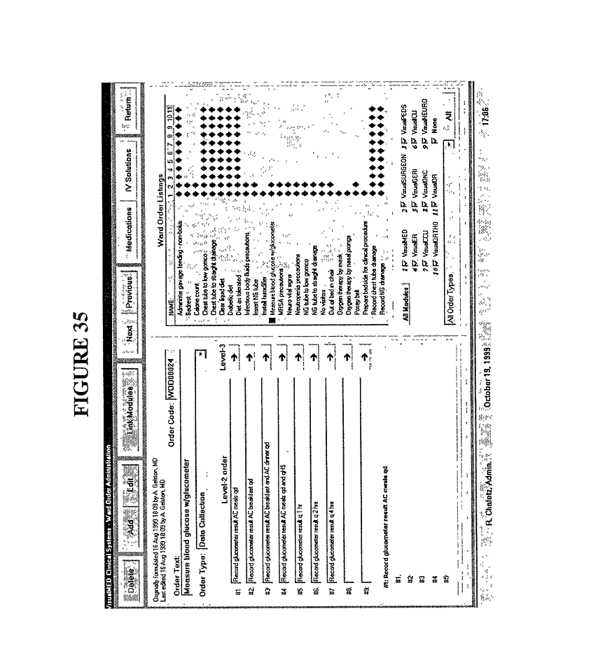

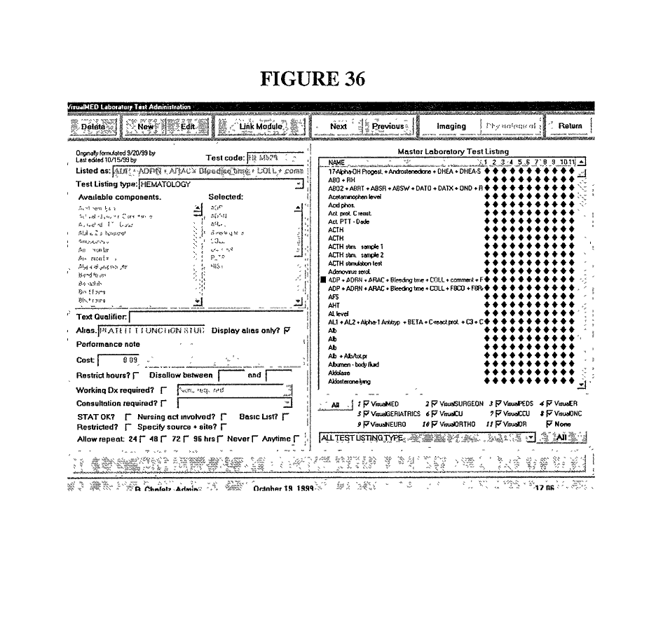

In one embodiment of the present invention a screen display can be accessed providing a means for triage order entry as illustrated in FIG. 33. In this example, by selecting a working diagnosis of abdominal pain a standard set of triage lab and image examinations are brought forward providing a means for the hospital personnel to order a set of tests appropriate to the working diagnosis.

Wireless Capabilities of the System

In one embodiment of the present invention, portions or all of the communication within the local area network of the hospital informatics system can be provided by radio transmission, thus eliminating the need for cables within all or portions of the system. This type of wireless system would provide a means for the use of portable interactive terminals having RF transmitter/receivers to be carried with for example physicians, nurses or other hospital personnel as they circulate through the institution. With this configuration, hospital personnel can access the informatics system at any given time and at any given location provided RF transmission is possible, thus providing a means for hospital personnel to view or enter information without the need for locating a hardwired interactive terminal. Furthermore, by enabling a plurality of clinical devices for example EKG's, fluid pumps, glucometers, or blood pressure cuffs with RF wireless transmission capabilities, these devices can transmit the generated results directly to the informatics system, providing a means for real time integration of the information into the system. Furthermore, these wireless clinical devices can be easily transported from location to location within the hospital without the need for connecting and disconnecting the device from the system, if appropriate.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the medium. Any suitable computer readable medium may be utilised including hard disks, CD-ROMs, optical storage devices, or magnetic storage devices.

The present invention is described below with reference to flowchart illustrations of methods, apparatus (systems) and computer program products according to embodiments of the invention. It will be understood that each block of the flowchart illustrations, and combinations of blocks in the flowchart illustrations, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer instructions.

Computer program for implementing the present invention may be written in various object-oriented programming languages, such as Delphi and Java.RTM.. However, it is understood that other object oriented programming languages, such as C++ and Smalltalk, as well as conventional programming languages, such as FORTRAN or COBOL, could be utilised without departing from the spirit and intent of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A computer-based system for providing decision support in a hospital environment comprising:
(a) a plurality of electronic color coded displays comprising data fields wherein the displays are modeled upon or closely depict hospital information formats selected from the list comprising: order forms, patient records, status reports, information screens, medical imaging results or lab results;
(b) a plurality of terminals, wherein each terminal has user interactive means for displaying the color coded images for user interaction with the system;
(c) biometric means operatively associated with each terminal for efficient identification of the authorized user;
(d) computer means enabling images to be accessed in an interactive manner by an authorized user;
(e) data storage means;
(f) a central data processing system supporting system logic wherein the central data processing system can transfer information between the plurality of terminals and one or more database servers;
(g) one or more database servers for transferring information between said data storage means and said central data processing system; and
(h) system logic, modeled on hospital procedures, wherein said logic comprises two types of decision support, one that is user interactive and one that functions independently of user commands.

2. The computer-based system according to claim 1, wherein said displays are comprise symbols that are used in a hospital.

3. The computer-based system according to claim 1, wherein said order forms are used for performing a task selected from the list comprising ordering diagnostic tests, ordering lab tests, prescribing medications and prescribing treatments.

4. The computer-based system according to claim 1, wherein said status reports provide data pertaining to requirements of an individual or a collection of individuals.

5. The computer-based system according to claim 1, wherein said information screens provide warnings with or without additional information.

6. The computer-based system according to claim 1, wherein said user interactive means is a touch screen.

7. The computer-based system according to claim 1, wherein said biometric means is an optical scanner.

8. The computer-based system according to claim 6, wherein said optical scanner recognizes the fingerprints, thumbprints or retina of the authorized users.
